(19) United States
(12) Patent Application Publication
(10) Pub. No.: US 2015/0339968 A1
(43) Pub. Date: Nov. 26, 2015

(54) LIQUID CRYSTAL DISPLAY DEVICE

(71) Applicant: SHARP KABUSHIKI KAISHA, Osaka (JP)

(72) Inventors: Takatomo YOSHIOKA, Osaka-shi (JP); Yuichi KITA, Osaka-shi (JP); Yoshiki NAKATANI, Osaka-shi (JP); Takao IMAOKU, Osaka-shi (JP); Iori AOYAMA, Osaka-shi (JP)

(73) Assignee: Sharp Kabushiki Kaisha, Osaka (JP)

(21) Appl. No.: 14/652,138

(22) PCT Filed: Dec. 10, 2013
(86) PCT No.: PCT/JP2013/083014

§ 371 Date: Jun. 15, 2015

(30) Foreign Application Priority Data
Dec. 17, 2012 (JP) 2012-274923

(51) Int. Cl. G09G 3/20; G02F 1/1368; G09G 3/34; G02F 1/1335

(52) U.S. Cl. CPC G09G 3/2007; G02F 1/133621; G02F 1/1368; G09G 3/3413; G02F 2001/133622; G09G 2320/0271; G09G 2320/0242

(57) ABSTRACT

The present invention provides a field sequential liquid crystal display device which can provide display with an appropriate gray scale value in a period when the period succeeds a period in which the light source in the backlight unit is turned off. The liquid crystal display device of the present invention includes a liquid crystal display device includes a liquid crystal display panel including a pair of substrates, a liquid crystal layer sandwiched between the substrates, and a display area formed by multiple pixels; a backlight unit that includes multi-color light sources and is configured to sequentially emit lights in different colors for individual multiple sub-frames obtained by temporally diving one frame; and a controller configured to control a liquid crystal gray scale value of each of the pixels by synchronizing with supply of each image signal to the multi-color light sources, at least one of the multi-color light sources being turned off for at least one of the sub-frames, the controller configured to control the liquid crystal gray scale value of each of the pixels when an image signal for turning off the light source is supplied to the light source to be turned off, so as to let the gray scale values satisfy the predetermined conditions.

### TECHNICAL FIELD

The present invention relates to a liquid crystal display device. More specifically, the present invention relates to a field sequential liquid crystal display device.

### BACKGROUND ART

A field sequential liquid crystal display device displays an image by dividing the image into multiple one-color images (e.g. images corresponding to three colors of red, green, and blue), and displaying the divided images in time sequence using pixels, differently from the method of providing display using multiple color filters (e.g. red, green, blue) for each pixel. More specifically, one frame for an image is divided into three sub-frames corresponding to the respective colors of red, green, and blue, and writing red, green, or blue image data for each sub-frame into the every pixel of the liquid crystal panel. The device then emits light corresponding to the image data color from the backlight unit arranged on the rear surface of the liquid crystal panel, so that these displayed colors are perceived as a color image by human eyes. A liquid crystal display device in such a system has advantages of a high transmittance and a high resolution compared to a liquid crystal display device employing a system with color filters.

In a liquid crystal display device in the field sequential system, however, switching between the colors of red, green, and blue for the individual sub-frames is likely to be visually perceivable, causing a phenomenon called color breakup. One way of preventing color breakup is, as disclosed in Patent Literature 1 for example, dividing the display area of the liquid crystal display device into three separate areas in advance, writing image data into each separate area, emitting light in a color corresponding to each image data from the light source, and displaying different unit-color images in the individual separate areas.

Also, field sequential liquid crystal display devices are required to write image data into pixels at a speed that is three or more times higher than the speed of a common liquid crystal display device in order to sequentially display the individual sub-frame images with pixels. Therefore, when the consecutive frames have greatly different gray scale values of an image to be displayed, the response of the liquid crystal may not be fast enough, and correct gray scale values corresponding to the image signals may not be displayed. Patent Literature 2, for example, deals with this problem by detecting the number of pixels with the maximum gray scale value for each color as the characteristic of image signals, and rearranging for each frame the order of luminescent colors from the backlight unit and the order of colors of image signals supplied to the liquid crystal panel, so as to reduce the difference in the numbers of pixels with the maximum gray scale value, i.e., in the increasing or decreasing order of the number of pixels with the maximum gray scale value of the colors.

### CITATION LIST

### Patent Literature

Patent Literature 1: JP 2005-316092 A

Patent Literature 2: JP 2010-250193 A

### SUMMARY OF INVENTION

### Technical Problem

However, the studies made by the present inventors show that, although the method disclosed in Patent Literature 2 can deal with the problem that an image with the correct gray scale values corresponding to the image signals cannot be displayed, the method can be employed only under the limited drive conditions in which any of the light sources in the backlight unit is turned on, and thus the method can still be improved. Also, since the method merely includes rearrangement of sub-frames, a sufficient effect may not be achieved.

The present invention has been made in view of the above current state of the art, and aims to provide a field sequential liquid crystal display device which can provide display with an appropriate gray scale value in a period when the period succeeds a period in which the light source in the backlight unit is turned off.

### Solution to Problem

The present inventors have made various studies on other methods for solving the problem that the correct gray scale value corresponding to the image signal cannot be expressed by the field sequential driving. As a result, the present inventors have focused on the liquid crystal gray scale value of each pixel in a sub-frame for which the light source is turned off in the algorithm (the gray scale value determined by the luminance level of the transmitted light when the liquid crystal is irradiated with a certain amount of light). Also, the inventors have focused on the problem that a conventional device cannot provide the desired gray scale value and cannot perform the correct driving when the gray scale values of the image to be displayed are greatly different between consecutive sub-frames. Here, correct liquid crystal gray scale values have been found to be displayed by, when one frame includes a sub-frame with a gray scale value of 0, considering this sub-frame as a preparation period for the next sub-frame, and controlling the liquid crystal gray scale values of the pixels not to be 0 while turning off the light source, thereby reducing the difference in the required liquid crystal gray scale value between the sub-frame and the next sub-frame. The method is summarized below with reference to the drawings.

FIG. 16 and FIG. 17 are schematic views each illustrating one example of a drive controlling method for a conventional field sequential liquid crystal display device. In the example illustrated in FIG. 16, one frame includes one sub-frame for which the light source is turned off. In the example illustrated in FIG. 17, one frame includes two sub-frames for which the light source is turned off. In FIG. 16 and FIG. 17, the bar chart shows the luminance levels of lights emitted from the backlight unit (B/L luminance levels), wherein a two-dot chain line indicates a gray scale value corresponding to an image signal, and a dashed line indicates the gray scale value actually displayed.

FIG. 16 shows the case where one frame includes four sub-frames, in which one of the sub-frames has a gray scale value of 0 (color B: black), and the other sub-frames are of the respective color A, color C, and color D. FIG. 17 shows the case where one frame includes four sub-frames, in which two of the sub-frames have a gray scale value of 0 (color A: black, color C: black), and the other two sub-frames are of the respective color B and color D.

For the sub-frames of the color A, color C, and color D, the light source (BL) is turned on. However, when black insertion is performed as in the case of the sub-frame of the color B, the liquid crystal does not need to be moved during the sub-frame. Hence, usually, voltage is not applied to the liquid crystal and the light source is turned off, such that the power consumption is maintained at the minimum. Also, during the response period of the liquid crystal, the light source is usually turned off, and the light source is turned on only during the period for which display is performed. FIG. 16 and FIG. 17 both show the case of performing black insertion, and the conditions are the same for black display with local dimming.

However, as shown in FIG. 16 and FIG. 17, when the gray scale value is decreased to 0 for the period of a sub-frame of the color B, it is difficult to raise the gray scale value to a desired level for the next sub-frame of the color C. This problem is characteristic of the field sequential driving in which a desired gray scale value needs to be achieved by one writing operation. More specifically, when voltage is written into a pixel with the TFT turned on, and then a thin-film transistor (TFT) is turned off, the electrode within the TFT is floated. This writing leads to application of voltage to the liquid crystal layer, which changes the alignment of liquid crystal molecules, followed by a change in the liquid crystal capacitance. Since the charge state changes to a regular state (i.e. charge transfer occurs) in this system, the potential level of pixel electrodes immediately after writing is different from the potential level of pixel electrodes after alignment change of the liquid crystal. That is, the voltage level expected to be written in advance and the voltage level actually applied to the liquid crystal layer in the regular liquid crystal state are different. A phenomenon that the liquid crystal cannot provide a sufficient response due to this voltage difference is typically called “step response”. In driving of a common liquid crystal display device utilizing color filters, writing is performed multiple times for one frame, and thus the gray scale value can be raised to the desired gray scale value by the multiple writing operations. In the case of the field sequential system, however, the desired gray scale value needs to be achieved by one time of writing as described above. Accordingly, if the gray scale value for the immediately preceding sub-frame is 0, the gray scale value is raised to a value slightly lower than the desired value, which makes it difficult to provide display with a correct gray scale value. Here, as illustrated in FIG. 18, the state (period A) in which the alignment direction of the liquid crystal molecules is changed and the transmittance is temporally changed is referred to as a “transient response” state, and the state (period B) in which the transmittance is temporally stable is referred to as a “stationary state”.

It is also possible to perform overshoot driving in anticipation of the decrease in order to achieve the desired gray scale value after the step response, but this method is not enough as a solution because there could be regions or conditions where further overshoot driving cannot be performed. The overshoot driving can be performed after the transmittance is decreased, but here, the transmittance, which is an important parameter, is sacrificed.

Meanwhile, the basic concept of the present invention is described below. FIG. 1 is a schematic view illustrating one example of the drive controlling method in one frame in the field sequential liquid crystal display device of the present invention. In the example illustrated in FIG. 1, one frame includes one sub-frame for which the light source is turned off. In FIG. 1, the solid line indicates the liquid crystal gray scale value of one embodiment of the liquid crystal display device of the present invention, and the dashed line indicates the liquid crystal gray scale value of a conventional liquid crystal display device.

FIG. 1 also shows the case where one frame includes four sub-frames, in which one of the sub-frames has a gray scale value of 0 (color B: black), and the other sub-frames are of the respective color A, color C, and color D. In the present invention, however, the liquid crystal gray scale value is controlled such that it does not reach 0 in the sub-frame of the color B. Since the light source is turned off for the sub-frame of the color B, the display performance is not affected even when the alignment orientation of the liquid crystal molecules is changed. The smaller the liquid crystal gray scale value change from that of the immediately preceding sub-frame, the smaller the liquid crystal capacitance change and the less likely a step response to occur. Therefore, adjusting the liquid crystal gray scale value of the sub-frame of the color B allows the liquid crystal gray scale value of the sub-frame of the color C to be increased to a height never reached by the conventional art.

In the present invention, the overshoot driving can be performed if necessary, and if black display is performed in a partial area, a measure can be taken if necessary in consideration of the effect of light from the backlight in the other areas. These measures are described in detail later.

Consequently, the present inventors have solved the above problems, completing the present invention.

That is, one aspect of the present invention is a liquid crystal display device including: a liquid crystal display panel including a pair of substrates, a liquid crystal layer sandwiched between the substrates, and a display area formed by multiple pixels;

a backlight unit that includes multi-color light sources and is configured to sequentially emit lights in different colors for individual multiple sub-frames obtained by temporally diving one frame; and

a controller configured to control a liquid crystal gray scale value of each of the pixels by synchronizing with supply of each image signal to the multi-color light sources,

at least one of the multi-color light sources being turned off for at least one of the sub-frames,

the controller configured to control the liquid crystal gray scale value of each of the pixels when an image signal for turning off the light source is supplied to the light source to be turned off, so as to let the gray scale values satisfy the conditions of:

(i) A>B and B≧C, in the case of A>C;
(ii) A<B and B≦C, in the case of A<C; and
(iii) A=B and B=C, in the case of A=C,
   wherein A is a liquid crystal gray scale value of a sub-frame that precedes a sub-frame for which the light source is to be turned off; B is a liquid crystal gray scale value of the sub-frame for which the light source is to be turned off; and C is a liquid crystal gray scale value of a sub-frame that succeeds the sub-frame for which the light source is to be turned off.

The configuration of the liquid crystal display device is not especially limited by other components as long as it essentially includes such components. More specific aspects of the liquid crystal display device include the following aspects.

In one aspect, the controller is configured to control the liquid crystal gray scale value of, among the multiple sub-frames, a sub-frame for which one of the multi-color light sources is turned off, the sub-frame immediately preceding a sub-frame for which the multi-color light source is turned on.

In another aspect, the controller is configured to control the liquid crystal gray scale value of, among the multiple sub-frames, a sub-frame for which at least one of the multi-color light sources is turned off, the sub-frame immediately preceding a sub-frame for which the multi-color light source is turned on to emit light in a color with the highest gray scale value of the at least one of the multiple color light sources.

In yet another aspect, the controller is configured to control the liquid crystal gray scale value of, among the multiple sub-frames, at least two consecutive sub-frames for which at least one of the multi-color light sources are turned off, the at least two consecutive sub-frames immediately preceding a sub-frame for which a light source is turned on to emit light in a color with the highest gray scale value of the at least one of the multiple color light sources.

In yet another aspect, the controller is configured to perform overshoot driving in the liquid crystal layer for, among the multiple sub-frames, a sub-frame for which the multi-color light source is turned off, the sub-frame immediately preceding a sub-frame for which the multi-color light source is turned on.

In yet another aspect, the multiple sub-frames include only one sub-frame for which the multi-color light source is turned off.

In yet another aspect, the multiple sub-frames include multiple sub-frames for which the multi-color light source is turned off.

In yet another aspect, every pixel in the display area of the liquid crystal display panel includes a sub-frame for which the multi-color light source is turned off.

In yet another aspect, part of the pixels in the display area of the liquid crystal display panel includes a sub-frame for which the multi-color light source is turned off.

In yet another aspect, the liquid crystal display device further includes a thin-film transistor including a semiconductor layer, wherein the semiconductor layer contains indium, gallium, zinc, and oxygen.

### Advantageous Effects of Invention

The present invention can provide display with an appropriate gray scale value even if the light source in the backlight unit is turned off for a period.

### BRIEF DESCRIPTION OF DRAWINGS

FIG. 1 is a schematic view illustrating one example of a drive controlling method in one frame in a field sequential liquid crystal display device of the present invention, or Embodiment 1, 2, or 4.

FIG. 2 is a schematic view illustrating one example of a drive controlling method in one frame in a liquid crystal display device of Alternative Example 1.

FIG. 3 is a schematic view illustrating one example of a drive controlling method in one frame in a liquid crystal display device of Alternative Example 2.

FIG. 4 is a schematic view illustrating one example of the drive controlling method in one frame in a field sequential liquid crystal display device of Embodiment 3.

FIG. 5 is a schematic view illustrating one example of the drive controlling method in one frame in a field sequential liquid crystal display device of Embodiment 5.

FIG. 6 is a schematic view illustrating another example of the drive controlling method in one frame in the field sequential liquid crystal display device of Embodiment 5.

FIG. 7 is a schematic view illustrating yet another example of the drive controlling method in one frame in the field sequential liquid crystal display device of Embodiment 5.

FIG. 8 is a schematic cross-sectional view of the liquid crystal display device of any one of Embodiments 1 to 5 in a vertical electric field mode.

FIG. 9 is a schematic cross-sectional view of the liquid crystal display device of any one of Embodiments 1 to 5 in a horizontal electric field mode (IPS mode).

FIG. 10 is a schematic cross-sectional view of the liquid crystal display device of any one of Embodiments 1 to 5 in a horizontal electric field mode (FFS mode).

FIG. 11 is an exploded perspective view of a liquid crystal display device of any one of Embodiments 1 to 5.

FIG. 12 is a schematic cross-sectional view of one embodiment of an ON-ON switching mode liquid crystal display device in rising.

FIG. 13 is a schematic cross-sectional view of one embodiment of an ON-ON switching mode liquid crystal display device in falling.

FIG. 14 is a schematic plan view of a TFT and the surrounding region thereof in the liquid crystal display device of any one of Embodiments 1 to 5.

FIG. 15 is a schematic cross-sectional view taken along the I-J line in FIG. 14.

FIG. 16 is a schematic view illustrating one example of the drive controlling method of a conventional field sequential liquid crystal display device (an example in which one frame includes one sub-frame for which the light source is turned off).

FIG. 17 is a schematic view illustrating an example of the drive controlling method of a conventional field sequential liquid crystal display device (an example in which one frame includes two sub-frames for which the light source is turned off).

FIG. 18 is a schematic view illustrating the “transient response” and “stationary state” of liquid crystal.

### DESCRIPTION OF EMBODIMENTS

The present invention will be described in more detail below with reference to the drawings based on embodiments which, however, are not intended to limit the scope of the present invention.

The “liquid crystal gray scale value” herein refers to a gray scale value defined using the luminance level (or transmittance) when the liquid crystal is irradiated with a certain amount of light from the light sources (backlight). Also, the simple “gray scale value” refers to the actual gray scale value including the luminance level (variable) of the light from the light sources. For example, in the state in which a voltage equal to or higher than the threshold is applied to the liquid crystal and the light source is turned off, the gray scale value is 0 but the liquid crystal gray scale value is not 0.

The “liquid crystal gray scale value” in Embodiments 1 to 5 can be defined by setting the luminance level of the backlight to a certain level or arranging another light source with a certain level of luminance at the side of the liquid crystal display panel, and then measuring the gray scale value of the liquid crystal display panel.

All the following Embodiments 1 to 5 employ a field sequential liquid crystal display device. A field sequential liquid crystal display device provides color display by a time division system, differently from the space division system which utilizes three color filters per pixel. Hence, in the following Embodiments 1 to 5, the field sequential system can achieve light use efficiency which is about three times the light use efficiency of the color filter system, and is very favorable as a low power consumption technique.

There are various color display methods in the field sequential system, such as a method of simply using three colors of red, green, and blue for sub-frames (single color system), and a method of expressing colors with sub-frames the number of which is greater than the number of original colors (mixed color system). Both the single color system and the mixed color system can be applied to the following Embodiments 1 to 5. In the case that the light source is a light emitting diode (LED), the color of each LED can be used, and display with wide color reproduction range can be achieved. Here, the kind, number, and order of the light-emitting colors are not particularly limited.

The liquid crystal display device of any of the following Embodiments 1 to 5 cannot be applied to a drive system in which all the light sources are turned on for every sub-frame, but can be applied to any drive method which partially includes a sub-frame for which the light source is turned off.

The liquid crystal display device of any of the following Embodiments 1 to 5 can be applied if the drive system includes at least two sub-frames in one frame.

The liquid crystal display device of any of the following Embodiments 1 to 5 is applicable to any display mode such as a twisted nematic (TN) mode, a vertical alignment (VA) mode, an in-plane switching (IPS) mode, a fringe field switching (FFS) mode, a transverse bend alignment (TBA) mode, an optically compensated bend (OCB) mode, and an ON-ON Switching mode. Since all these modes have the step response problem, the following Embodiments 1 to 5 are suitable. The following Embodiments 1 to 5 are suitable for any other display mode as long as there can be the step response problem.

In the drawings mentioned below, the backlight luminance (B/L luminance) is set at the same level for the sake of simplicity. However, the luminance levels may be different if certain conditions of the liquid crystal gray scale are satisfied.

In the following Embodiments 1 to 5, the basic method for controlling the liquid crystal gray scale value is application of voltage to the liquid crystal layer. Voltage can be applied by multiple electrodes formed on one or both of the pair of substrates. Here, however, the gray scale value cannot always be defined based on the potential difference between the pair of electrodes because the electric field generated in the liquid crystal layer changes depending on the position and number of electrodes formed. Still, in a mode in which the alignment of liquid crystal molecules is controlled based on the potential difference between the pair of substrates, correlation is basically generated between the level of voltage applied and the liquid crystal gray scale value (e.g. the liquid crystal gray scale value increases as the applied voltage increases), and thereby the liquid crystal gray scale value can be defined (compared).

The configuration of the liquid crystal display device of any of the following Embodiments 1 to 5 is detectable by determining the presence of black sub-frames during driving and the alignment state of the liquid crystal in the sub-frames by using a device such as a photodiode or an optical microscope. The configuration is also detectable by measurement of drive voltage.

### Embodiment 1

### The Case where there is a Sub-Frame Causing the Entire Area to be Black

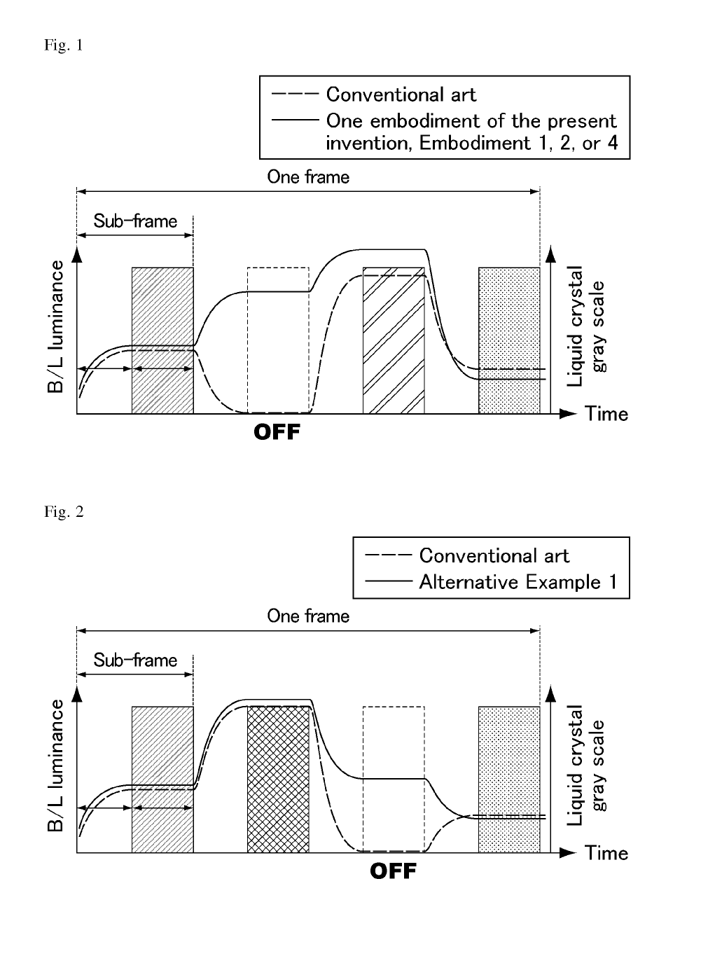

FIG. 1 is a schematic view illustrating one example of a drive controlling method in one frame in the field sequential liquid crystal display device of Embodiment 1. In Embodiment 1, one frame includes multiple sub-frames, and the sub-frames include at least one sub-frame for which the light source is turned off.

In the example shown in FIG. 1, one frame includes four sub-frames, in which the second sub-frame has a gray scale value of 0 (color B: black), and the other sub-frames are of the respective color A, color C, and color D. In FIG. 1, the solid line indicates a liquid crystal gray scale value of one embodiment of the liquid crystal display device of the present invention, and the dashed line indicates the liquid crystal gray scale value of a conventional liquid crystal display device.

In the field sequential system, a case is possible in which black display is performed in one area while color display is performed in the surrounding area thereof. Still, when there is a sub-frame causing the entire display area to be black as in the case of Embodiment 1, the influence of the backlight in the surrounding area is not necessarily considered. Hence, the liquid crystal gray scale value (how much the liquid crystal is tilted) can be selected with a high degree of freedom.

In the example illustrated in FIG. 1, in order to increase the gray scale achievement ratio of the liquid crystal in the third sub-frame, the liquid crystal gray scale value (B) for the second sub-frame is designed to fall between the liquid crystal gray scale value (A) for the first sub-frame and the liquid crystal gray scale value (C) for the third sub-frame. That is, the example shows the case that A<C, and both of the conditions A<B and B≦C are satisfied. Thereby, as illustrated in FIG. 1, the gray scale achievement ratio in the third sub-frame is improved, and therefore correct gray scale display is enabled.

In this manner, keeping the liquid crystal gray scale value from decreasing to 0 in a black sub-frame immediately preceding the target sub-frame enables an increase in the gray scale achievement ratio in the immediately succeeding target sub-frame.

In Embodiment 1, if the liquid crystal gray scale value is controlled in the black sub-frame immediately preceding the target sub-frame, the other sub-frames are not particularly limited the liquid crystal gray scale values for the other sub-frames.

The relations of A to C are not necessarily satisfied in one frame. That is, even if the relations are satisfied over frames, the liquid crystal display device can correspond to the liquid crystal display device of the present embodiment as long as the individual sub-frames satisfy the above conditions.

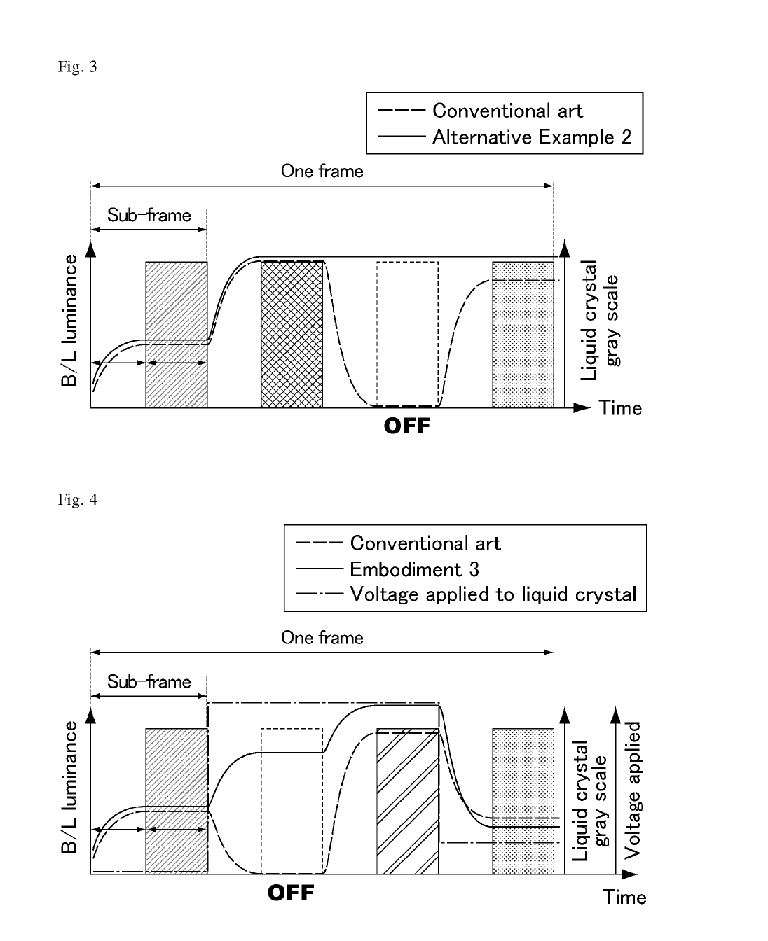

Although the case of A<C was described with reference to FIG. 1, the same applies to the case of A>C. That is, as illustrated in FIG. 2, the liquid crystal gray scale value (B) for the third sub-frame may be designed to fall between the liquid crystal gray scale value (A) for the second sub-frame and the liquid crystal gray scale value (C) for the fourth sub-frame (the relation satisfying both A>B and B≧C: Alternative Example 1). Also in the case of A=C, as illustrated in FIG. 3, the liquid crystal gray scale value (B) for the third sub-frame may be designed to be the same as the liquid crystal gray scale value (A) for the second sub-frame and the liquid crystal gray scale value (C) for the fourth sub-frame (the relation satisfying both A=B and B=C: Alternative Example 2).

### Embodiment 2

### The Case in which there is a Black Sub-Frame in a Partial Area

Basically, the configuration is the same as that in Embodiment 1. However, in the case that black display is performed in a partial area and color display is performed in the other areas in one sub-frame, enter of light for the area therearound from the backlight has to be taken into consideration for the area with black display.

FIG. 1 is also a schematic view illustrating one example of the drive controlling method in one frame in the field sequential liquid crystal display device of Embodiment 2. In FIG. 1, the solid line indicates the liquid crystal gray scale value of the liquid crystal display device of Embodiment 2. In Embodiment 2, the liquid crystal gray scale value of the second sub-frame is preferably brought as close as possible to the liquid crystal gray scale value of the third sub-frame. Thereby, although not perfect, a very high improvement effect can be achieved. For Embodiment 2, a case is expected in which light from the backlight unit is controlled for each area by local dimming.

### Embodiment 3

### Overshoot Driving

FIG. 4 is a schematic view illustrating one example of the drive controlling method in one frame in a field sequential liquid crystal display device of Embodiment 3. In Embodiment 3, one frame includes multiple sub-frames, and the sub-frames include at least one sub-frame for which the light source is turned off. For the sub-frame for which the light source is turned off, overshoot driving is employed. That is, Embodiment 3 is a case in which the overshoot driving is employed for a sub-frame for which the light source is turned off, based on Embodiment 1 or 2. If the effects cannot be sufficiently achieved by the method in Embodiment 1 or 2, performing such overshoot driving if necessary allows a further increase in the gray scale achievement ratio.

In the example illustrated in FIG. 4, one frame includes four sub-frames, in which the second sub-frame has a gray scale value of 0 (color B: black), and the other three sub-frames are of the color A, color C, and color D. In FIG. 4, the solid line indicates the liquid crystal gray scale value of the liquid crystal display device of Embodiment 3, the dashed line indicates the liquid crystal gray scale value of a conventional liquid crystal display device, and one-dot chain line indicates liquid crystal voltage application.

As illustrated in FIG. 4, in Embodiment 3, the overshoot driving is performed for the second sub-frame, which is the black sub-frame, and as a result, the liquid crystal gray scale value of the second sub-frame and the liquid crystal gray scale value of the third sub-frame are at almost the same height.

In this manner, performing the overshoot driving for the black sub-frame immediately preceding the target sub-frame enables more certain provision of the gray scale achievement ratio for the immediately succeeding sub-frame. Also, the transient response can be reduced by the overshoot driving, and thus is effective in the field sequential system which requires a high frequency.

Here, the overshoot driving refers to a driving method of applying a voltage different from (i.e. higher than or lower than) the voltage usually applied.

In Embodiment 3, if the overshoot driving is performed for the sub-frame immediately preceding the target sub-frame, the overshoot driving may be performed for any other sub-frames (e.g. the target sub-frame).

The concept of Embodiment 3 is applicable to both Embodiments 1 and 2.

### Embodiment 4

### The Case in which there is Only One Black Sub-Frame in One Frame

FIG. 1 is also a schematic view illustrating one example of the drive controlling method in one frame in a field sequential liquid crystal display device of Embodiment 4. In Embodiment 4, one frame includes multiple sub-frames, and the sub-frames include only one sub-frame for which the light source is turned off. In FIG. 1, the solid line indicates the liquid crystal gray scale value of the liquid crystal display device of Embodiment 4.

In the example illustrated in FIG. 1, one frame includes four sub-frames, in which one of the sub-frames has a gray scale value of 0 (color B: black), and the other three sub-frames are of the color A, color C, and color D. Since the gray scale achievement ratio is increased for the third sub-frame, the liquid crystal gray scale value of the second sub-frame is designed to fall between the liquid crystal gray scale value of the first sub-frame and the liquid crystal gray scale value of the third sub-frame.

The concept of Embodiment 4 is applicable only to the case in which a black sub-frame immediately precedes the sub-frame for which color display is performed, and the concept is particularly suitable in the case in which a black sub-frame immediately precedes the sub-frame of the color with the highest gray scale value.

The concept of Embodiment 4 is applicable to any of Embodiments 1 to 3.

### Embodiment 5

### The Case in which there are Multiple Black Sub-Frames in One Frame

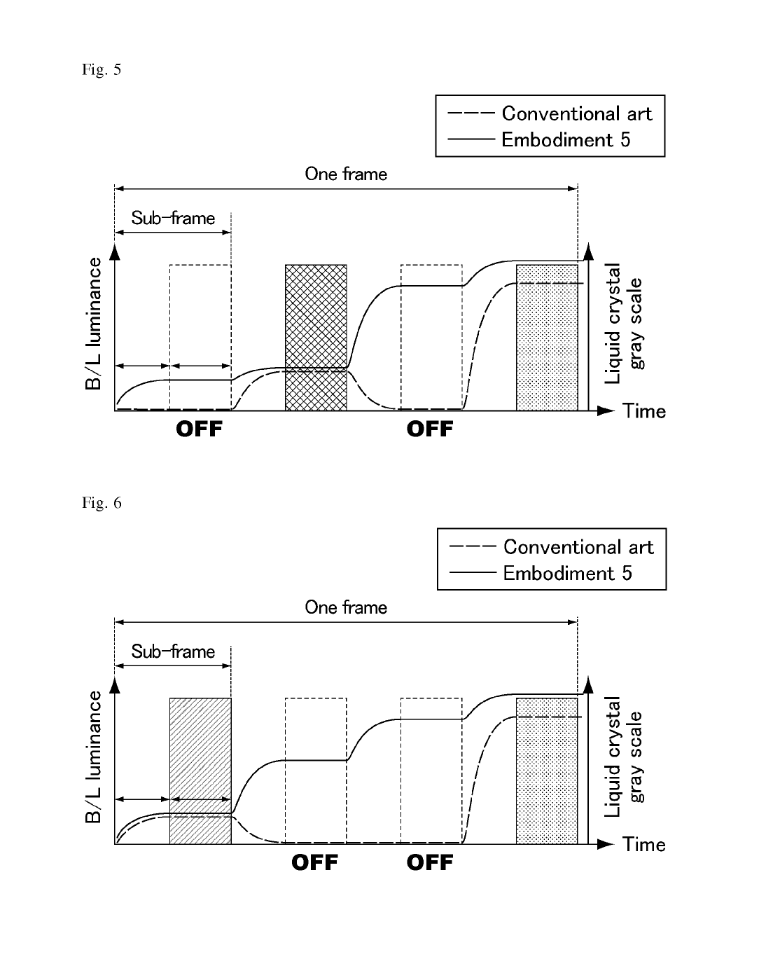

FIG. 5 to FIG. 7 are schematic views each illustrating an example of the drive controlling method in one frame in the field sequential liquid crystal display device of Embodiment 5. In Embodiment 5, one frame includes multiple sub-frames, and the sub-frames include at least two sub-frames for which the light source is turned off. In FIG. 5 to FIG. 7, the solid line indicates a liquid crystal gray scale value of Embodiment 5, and the dashed line indicates the liquid crystal gray scale value of a conventional liquid crystal display device.

In the example illustrated in FIG. 5, one frame includes four sub-frames, in which two of the sub-frames have a gray scale of 0 (color A: black, color C: black), and the other two sub-frames are of the respective color B and color D. The black sub-frames (color A, color C) respectively immediately precede the sub-frames (color B, color D) displayed in color. Thereby, the gray scale value for the second sub-frame can be controlled in the first sub-frame, and the gray scale value for the fourth sub-frame can be controlled in the third sub-frame.

In the example illustrated in FIG. 6, one frame includes four sub-frames, in which two of the sub-frames have a gray scale of 0 (color B: black, color C: black), and the other two sub-frames are of the respective color A and color D. The consecutive two black sub-frames (color B, color C) immediately precede the sub-frame of a color with the highest gray scale value. In the example illustrated in FIG. 6, the two black sub-frames (color B, color C) are controlled to have different liquid crystal gray scale values. More specifically, the liquid crystal gray scale value is controlled to increase stepwise in the two black sub-frames (color B, color C). In this manner, when black sub-frames with two respective gray scale values come between the first sub-frame and the fourth sub-frame which are displayed in colors, more correct gray scale display can be provided in the fourth sub-frame by gradually increasing the liquid crystal gray scale value in these black sub-frames.

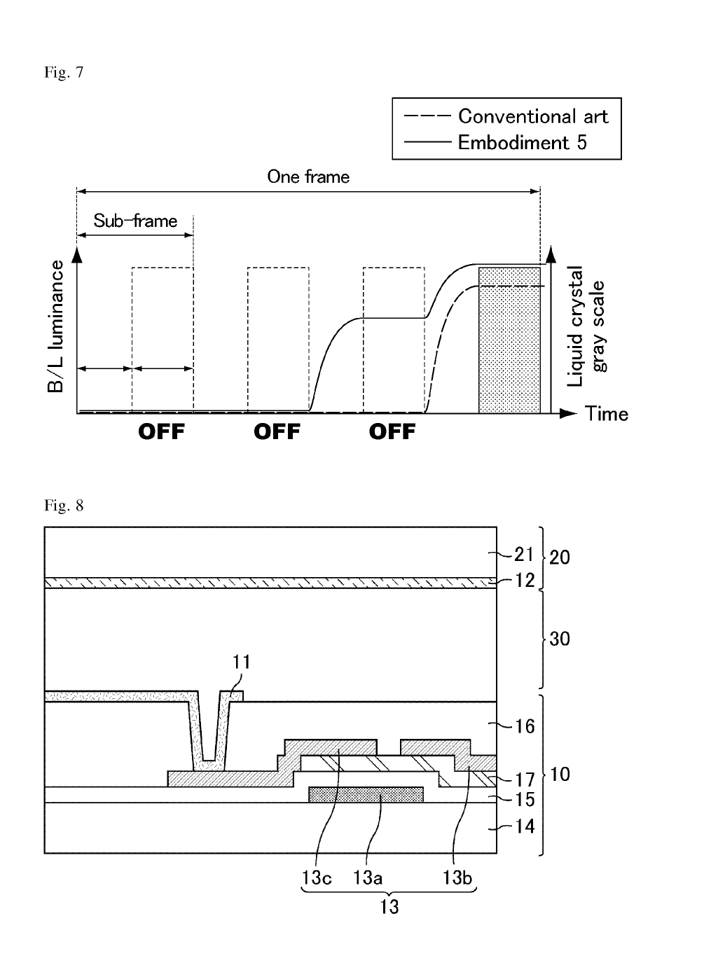

In the example illustrated in FIG. 7, one frame includes four sub-frames, and three of the sub-frames have a gray scale value of 0 (color A: black, color B: black: color C: black), and the other sub-frame is of the color D. Although the liquid crystal gray scale value is not controlled for the first two black sub-frames (color A, color B) in the example illustrated in FIG. 7, the liquid crystal gray scale value is controlled in the third sub-frame (color C). The gray scale achievement ratio for the fourth sub-frame is thereby improved, so that correct gray scale display is enabled.

As described above, in Embodiment 5, in the case that there are two consecutive black sub-frames, the gray scale value may be controlled to be the same for these sub-frames, or the gray scale value may be controlled to gradually increase.

The concept of Embodiment 5 is applicable to all of Embodiments 1 to 3.

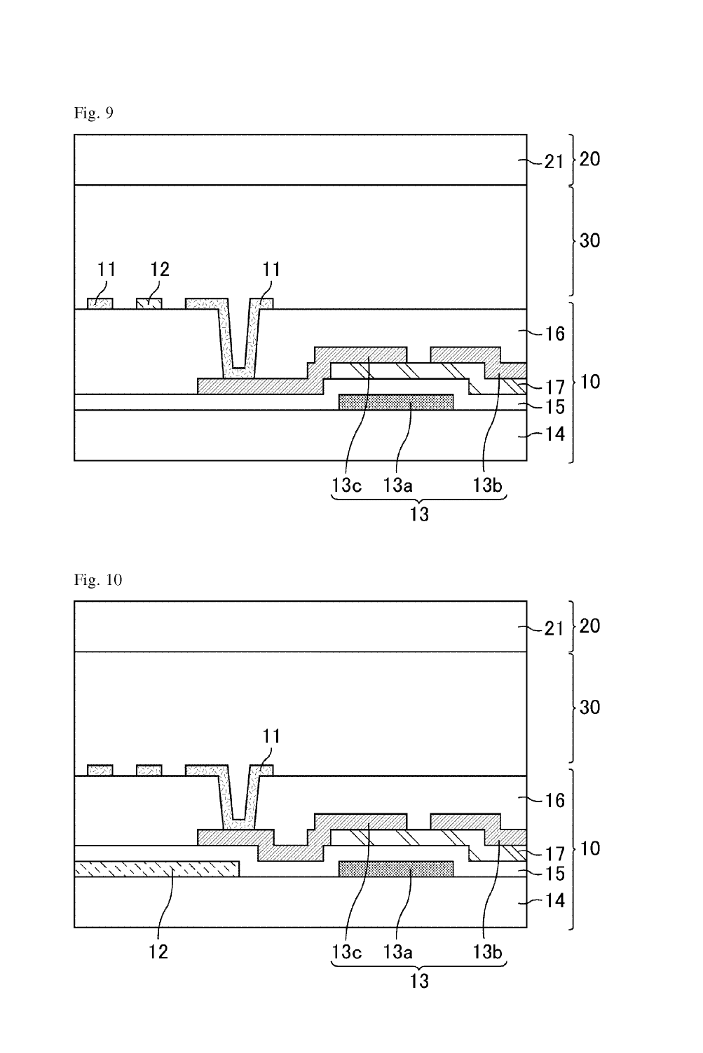

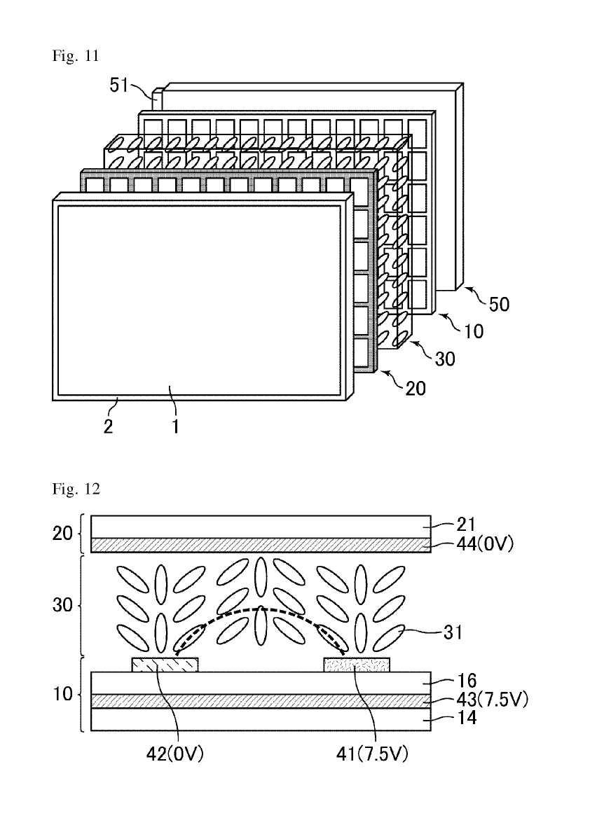

Hereinafter, the configuration common to the liquid crystal display devices of Embodiments 1 to 5 is described. FIG. 8 is a schematic cross-sectional view of the liquid crystal display device of any one of Embodiments 1 to 5 in a vertical electric field mode. FIG. 9 and FIG. 10 are each a schematic cross-sectional view of the liquid crystal display device of any one of Embodiments 1 to 5; FIG. 9 shows the case of the IPS mode, and FIG. 10 shows the case of the FFS mode. FIG. 11 is an exploded perspective view of the liquid crystal display device of any one of Embodiments 1 to 5. As illustrated in FIG. 8 to FIG. 11, the liquid crystal display device of any one of Embodiments 1 to 5 is provided with a liquid crystal display panel 40 including an array substrate 10, a counter substrate 20, and a liquid crystal layer 30 sandwiched between the array substrate 10 and the counter substrate 20 which are a pair of substrates. At the back of the liquid crystal display panel 40, a backlight unit 50 is provided. Neither of the array substrate 10 nor the counter substrate 20 is provided with a color filter. The backlight unit 50 is provided with multi-color light sources 51.

As illustrated in FIG. 8 to FIG. 11, the array substrate 10 of the liquid crystal display panel 40 is provided with components such as an insulating transparent substrate 14 made of a material such as glass, conductive lines formed on the transparent substrate 14, pixel electrodes 11, and thin film transistors (TFTs) 13. The TFTs 13 and the pixel electrodes 11 are connected to one another though contact holes in an interlayer insulating film 16. The region corresponding to one pixel electrode 11 forms one pixel. Multiple pixels form a display area 1, and the surrounding area of the display area 1 is a casing area 2.

The TFTs 13 each include three electrodes of a gate electrode 13a, a source electrode 13b, and a drain electrode 13c, and a semiconductor layer 17. Between each electrode and the semiconductor layer, a gate insulating film 15 and the interlayer insulating film 16 are arranged in order to electrically separate them. The material of the semiconductor layer 17 can be amorphous silicon (a-Si), for example, but is preferably an oxide semiconductor, particularly indium gallium zinc oxide (IGZO). Since an oxide semiconductor such as IGZO has a very high degree of electron mobility, the TFTs 13 does not need to be larger, and thus a high aperture ratio can be achieved. One of the advantages of the field sequential system is achievement of a better transmittance which leads to low power consumption, because color filters are not used. Hence, use of an oxide semiconductor such as IGZO brings large improvement. In the case of a horizontal electric field mode, as illustrated in FIG. 9 and FIG. 10, a common electrode 12 is further arranged on the array substrate 10 side of the transparent substrate 14. On the surface of the array substrate 10, an alignment film is formed if necessary, and the initial alignment of the neighboring liquid crystal molecules can be defined.

As illustrated in FIG. 8 to FIG. 11, the counter substrate 20 of the liquid crystal display panel is provided with an insulating transparent substrate 21 made of a material such as glass, and a black matrix formed on the transparent substrate 21. In the case of the vertical electric field mode, as illustrated in FIG. 8, the common electrode 12 is further provided on the counter substrate 20 side of the transparent substrate 21. An alignment film is formed in the surface of the counter substrate 20 if necessary, and the initial alignment of the neighboring liquid crystal molecules can be defined.

The liquid crystal layer 30 is filled with a liquid crystal material. The liquid crystal material may be of any kind such as a material with a negative dielectric anisotropy or a material with a positive dielectric anisotropy, and can be appropriately selected depending on the display mode of the liquid crystal.

The case of a vertical electric field mode (e.g. TN mode, VA mode, OCB mode) was described with reference to FIG. 8, and the case of a horizontal electric field mode (e.g. IPS mode, FFS mode, TBA mode) was described with reference to FIG. 9 and FIG. 10. The display mode can be any other mode such as a display mode for liquid crystal which utilizes a vertical electric field in complex with a horizontal electric field (e.g. ON-ON switching mode). In the field sequential system, a very high response speed of the liquid crystal is desired, and thus the concept of any of Embodiments 1 to 5 is particularly suitably applicable to an ON-ON switching mode. This will be described in detail later.

In the liquid crystal display device of any of Embodiments 1 to 5, the array substrate 10, the liquid crystal layer 30, and the counter substrate 20 are stacked in the stated order from the rear side to the viewer side of the liquid crystal display device. A polarizing plate is mounted on the rear side of the array substrate 10. A polarizing plate is also mounted on the viewer side of the counter substrate 20. These polarizing plates each may be further provided with a retarder. These polarizing plates may be circular polarizing plates.

The back light unit 50 may be of any type such as an edge light type and a direct type. For a liquid crystal display device including a small screen, an edge light type backlight is widely used which is capable of providing display with a small number of light sources at low power consumption and is suitable for reduction in thickness.

For the light source 51 used in any of Embodiments 1 to 5, light emitting diodes (LEDs) that emit light in specific colors are suitable.

Examples of the component constituting the backlight unit 50 include the light sources, a reflective sheet, a diffusion sheet, a prism sheet, and a light guide plate. In an edge light type backlight, light emitted from the light sources enters the light guide plate from the side face of the guide plate, is emitted as a planar light from the main surface of the light guide plate through, for example, reflection or diffusion, passes through components such as the prism sheet, and is emitted as display light. In a direct type backlight, the light emitted from the light sources directly passes through components such as the reflective sheet, the diffusion sheet, and the prism sheet without passing through the light guide plate, and is emitted as display light.

The display area 1 may be divided into multiple areas. In this case, multi-color light source is arranged for each area.

The case of applying the liquid crystal display device of any one of Embodiments 1 to 5 to the ON-ON switching mode is described below.

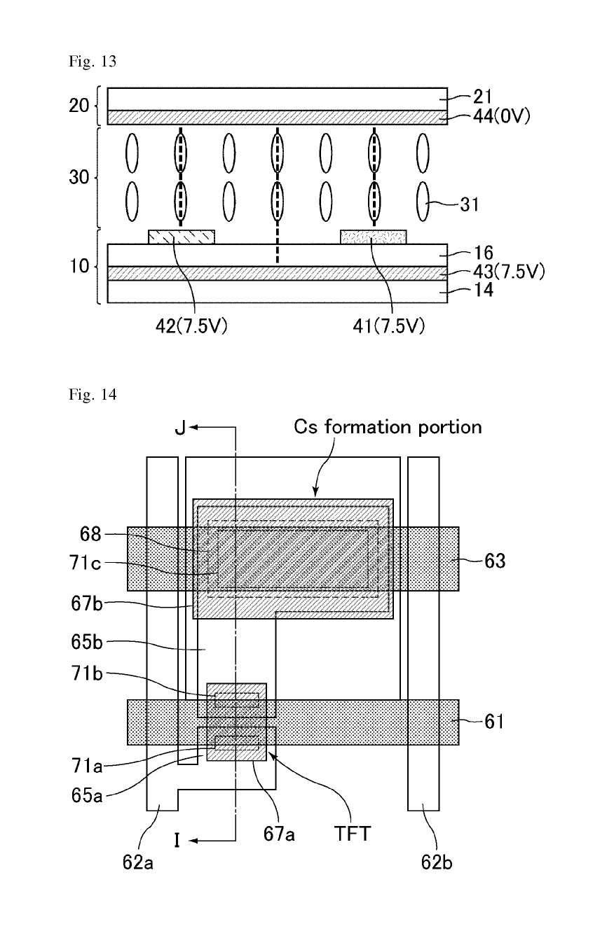

FIG. 12 is a schematic cross-sectional view of one embodiment of an ON-ON switching mode liquid crystal display device in rising. FIG. 13 is a schematic cross-sectional view of one embodiment of the ON-ON switching mode liquid crystal display device in falling. In FIG. 12 and FIG. 13, a dotted line indicates the direction of the electric field generated. The liquid crystal material used is positive liquid crystal (Δ∈>0). Also, the initial alignment of the liquid crystal molecules is a vertical alignment.

In the example illustrated in FIG. 12 and FIG. 13, the liquid crystal display device has the liquid crystal layer 30 sandwiched between the pair of substrates consisting of the array substrate 10 and the counter substrate 20. The array substrate 10 is provided with the transparent substrate 14, a lower electrode 43 formed on the transparent substrate 14, the interlayer insulating film 16, first upper electrodes 41 as pixel electrodes, and second upper electrodes 42 as a common electrode. The counter substrate 20 is provided with the transparent substrate 21 and the counter electrode 44 formed on the transparent substrate 21.

In rising, as illustrated in FIG. 12, a horizontal electric field is generated between the first upper electrodes 41 (7.5 V) and the second upper electrodes 42 (0 V), an oblique electric field is generated between the second upper electrodes 42 (0 V) and the lower electrode 43 (7.5 V), and a vertical electric field is generated between the first upper electrodes 41 (7.5 V) and the counter electrode 44 (0 V), so that the alignment of the liquid crystal molecules 31 is changed from the direction perpendicular to the substrate surfaces to an oblique direction (however, part of the liquid crystal molecules 31 is maintained in the vertical alignment).

As illustrated in FIG. 13, in falling, a vertical alignment is generated between the first upper electrodes 41 (7.5 V) and the counter electrode 44 (0 V), between the second upper electrodes 42 (7.5 V) and the counter electrode 44 (0 V), and between the lower electrode 43 (7.5 V) and the counter electrode 44 (0 V), so that the liquid crystal molecules 31 are all aligned in the direction perpendicular to the substrate surfaces.

In this manner, high speed response of the liquid crystal can be achieved by controlling the electric field generated between the individual electrodes in both rising and falling. That is, white display is provided by turning on application of voltage to each electrode in rising while black display is provided by turning on application of voltage to each electrode, and these displays are switched at a high speed.

Here, for the ON-ON switching mode, the number of electrodes, the structure and rearrangement place thereof, the level of voltage between the electrodes, and the liquid crystal characteristics are not limited if the rising and falling are controlled as described above.

In the case of performing the overshoot driving in the ON-ON switching mode, a higher or lower voltage than a usually applied voltage may be applied to each electrode in the liquid crystal display device, or both higher or lower voltages than a usually applied voltage may be applied to the electrodes. Also, a usually applied voltage may be applied to some of the electrodes. These may be appropriately combined in order to achieve the desired gray scale value in the next sub frame.

However, in the case of applying the ON-ON switching mode to the field sequential liquid crystal display device, the following characteristics are notable.

(1) In the ON-ON switching mode, the pixel capacitance is very large compared to that in the other modes (e.g. VA mode). (2) In the field sequential system, three pixels in multiple colors (e.g. red, green, and blue) in the other system (e.g. system using color filters) corresponds to one pixel, and thus the capacitance of one pixel is tripled. (3) In the field sequential system, high frequency driving (e.g. 240 Hz or higher) is required for prevention of color breakup, and the gate ON time is very short.

An effective measure to take for these problems is use of the oxide semiconductor (e.g. IGZO) described above for TFTs. Hereinafter, this measure is described in detail.

In the case of combining the ON-ON switching mode and the field sequential system, the pixel capacitance is numerous due to the above reasons (1) and (2). Here, if the conventional a-Si transistors are applied, the size of the transistors must simply be increased (specifically, about 20 or more times) to achieve the same characteristics, which decreases the aperture ratio.

Meanwhile, the electron mobility of IGZO is about 10 times that of a-Si, for example, and thus the size of the IGZO transistors can simply be reduced to about 1/10 of that of a-Si transistors. Since three transistors used in the color filter system can be integrated into one transistor in the field sequential system, the size of IGZO transistors in the field sequential system can almost be equal to or smaller than the size of a-Si transistors in the color filter system.

If the size of each transistor decreases as described above, the capacitance of Cgd (gate-drain capacitance) also decreases, and thereby the load on the source bus lines decreases.

In this manner, in the case of a display mode with a large pixel capacitance such as the ON-ON switching mode, use of an oxide semiconductor such as IGZO brings a great improvement.

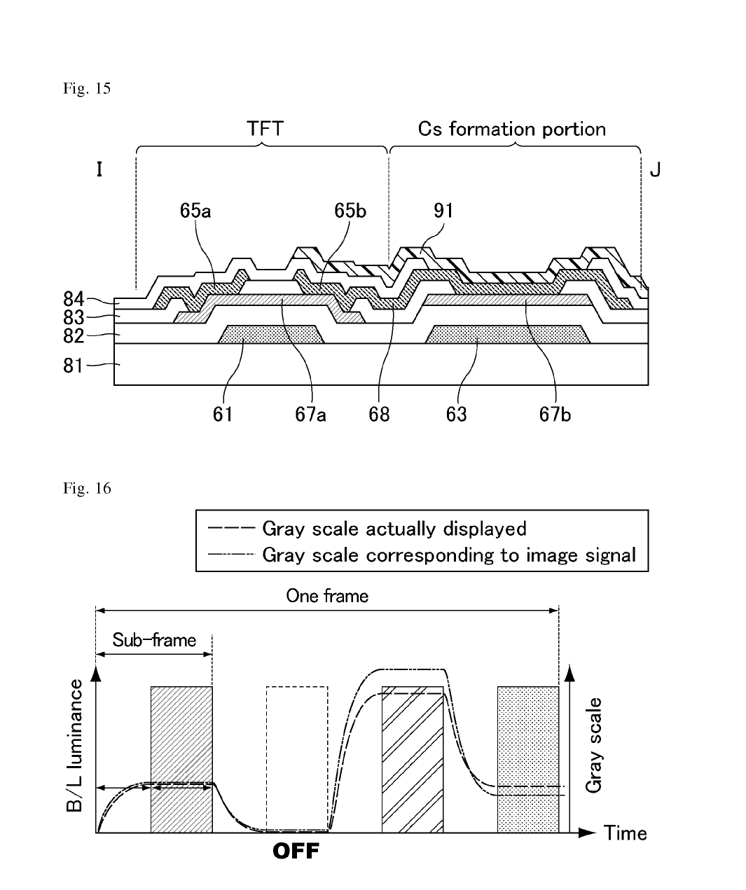

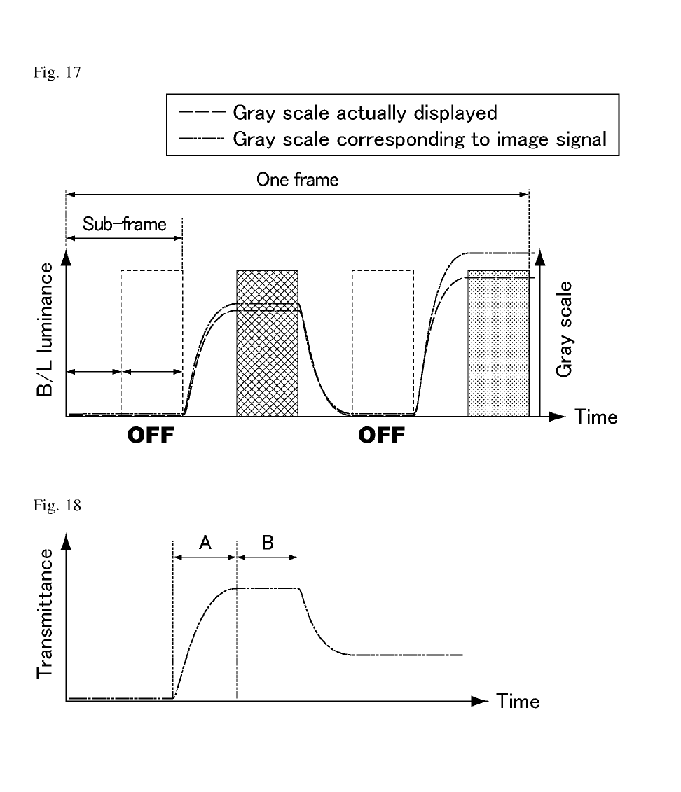

The structure of each TFT formed from an oxide semiconductor is described below. FIG. 14 is a schematic plan view of a TFT and the surrounding region thereof in the liquid crystal display device of any one of Embodiments 1 to 5. FIG. 15 is a schematic cross-sectional view taken along the I-J line in FIG. 14.

As illustrated in FIG. 14 and FIG. 15, around a TFT, a gate bus line 61 and source bus lines 62a and 62b are extended, and a Cs bus line 63 is formed in parallel with the gate bus line 61. A TFT is provided with a source electrode 65a, a drain electrode 65b, a gate electrode which is a part of the gate bus line 61, and an oxide semiconductor film 67a. The source electrode 65a and the drain electrode 65b are connected to one another through a first contact portion 71a, the oxide semiconductor film 67a, and a second contact portion 71b, and the electrodes are formed in the same layer, or in different layers with the transparent substrate 81, the gate insulating film 82, the first interlayer insulating film 83, and the second interlayer insulating film 84, for example. In the CS formation portion, an extended portion of a drain electrode 65b (hereinafter, also referred to as a Cs electrode 68) is used as an electrode adapted to form capacitance together with the Cs bus line, with the gate insulating film 82 therebetween. An oxide semiconductor film 67b is stacked on the lower side of the Cs electrode 68, and a pixel electrode 91 is stacked on the upper side of the Cs electrode 68. The Cs electrode 68 and the pixel electrode 91 are connected to one another through the second contact portion 71b.

One example of the step of producing TFTs and Cs formation portions using an oxide semiconductor is described below. The oxide semiconductor film 67a in each TFT and the oxide semiconductor film 67b in each Cs formation portion can be formed as described below.

First, an indium gallium zinc oxide (IGZO)-type semiconductor film with a thickness of 30 to 300 nm is formed on the gate insulating film 82 by sputtering. A resist mask covering a given region of the IGZO film is formed by photolithography. Subsequently, portions of the IGZO film not covered by the resist mask are removed by wet etching. Then, the resist mask is peeled off. In this manner, the island-shaped oxide semiconductor films 67a and 67b can be formed.

Subsequently, the first interlayer insulating film 83 is stacked on the entire surface of the transparent substrate 81 and the structure on the transparent substrate 81, and the film is patterned. The first interlayer insulating film 83 preferably includes an oxide film such as SiO₂, and is obtainable by forming a SiO₂ film with a thickness of about 150 nm by the CVD method. An oxide film is preferably used as an insulating film in contact with the oxide semiconductor films 67a and 67b because, even if oxygen deficiency occurs in the oxide semiconductor films 67a and 67b, the oxygen deficiency can be eliminated with use of oxygen contained in the oxide film. The first interlayer insulating film 83 may be a single layer film of a SiO₂ film, or may be a laminated film of a SiO₂ film as the lower layer and a SiNx film as the upper layer.

The first interlayer insulating film 83 has a thickness (in the case of a laminated film, the total thickness of the layers) of from 50 nm inclusive to 200 nm inclusive. If the thickness is larger than 50 nm, the surfaces of the oxide semiconductor films 67a and 67b can be more stably protected in the patterning step for the source electrodes and the drain electrodes. If the thickness is larger than 200 nm, a large step is generated between the source electrode and the drain electrode, which may cause defects such as breakage of the conductive lines.

The second interlayer insulating film 84 can be formed by the same materials and methods in the case of the first interlayer film.

The oxide semiconductor films 67a and 67b can be formed from, other than the indium gallium zinc oxide (IGZO)-type semiconductor, a zinc oxide (ZnO)-type semiconductor, an indium zinc oxide (IZO)-type semiconductor, or a zinc tin oxide (ZTO)-type semiconductor, for example.

### REFERENCE SIGNS LIST

1: Display area
2: Casing area
10: Array substrate
11, 91: Pixel electrode
12: Common electrode
13: Thin-film transistor (TFT)
13a: Gate electrode
13b, 65a: Source electrode
13c, 65b: Drain electrode
14, 21, 81: Transparent substrate
15: Gate insulating film
16: Interlayer insulating film
17: Semiconductor layer
20: Counter substrate
30: Liquid crystal layer
31: Liquid crystal molecule
40: Liquid crystal display panel
41: First upper electrode
42: Second upper electrode
43: Lower electrode
44: Counter electrode
50: Backlight unit
51: Light source
61: Gate bus line
62a, 62b: Source bus line
63: Cs Bus line
65a: Source electrode
65b: Drain electrode
67a, 67b: Oxide semiconductor film
68: Cs electrode
71a: First contact portion
71b: Second contact portion
71c: Third contact portion
82: Gate insulating film
83: First interlayer insulating film
84: Second interlayer insulating film

1. A liquid crystal display device comprising:
a liquid crystal display panel including a pair of substrates, a liquid crystal layer sandwiched between the substrates, and a display area formed by multiple pixels;
a backlight unit that includes multi-color light sources and is configured to sequentially emit lights in different colors for individual multiple sub-frames obtained by temporally diving one frame; and
a controller configured to control a liquid crystal gray scale value of each of the pixels by synchronizing with supply of each image signal to the multi-color light sources,
at least one of the multi-color light sources being turned off for at least one of the sub-frames,
the controller configured to control the liquid crystal gray scale value of each of the pixels when an image signal for turning off the light source is supplied to the light source to be turned off, so as to let the gray scale values satisfy the conditions of:
(i) A>B and B≧C, in the case of A>C;
(ii) A<B and B≦C, in the case of A<C; and
(iii) A=B and B=C, in the case of A=C,
wherein A is a liquid crystal gray scale value of a sub-frame that precedes a sub-frame for which the light source is to be turned off; B is a liquid crystal gray scale value of the sub-frame for which the light source is to be turned off; and C is a liquid crystal gray scale value of a sub-frame that succeeds the sub-frame for which the light source is to be turned off.

2. The liquid crystal display device according to claim 1,
wherein the controller is configured to control the liquid crystal gray scale value of, among the multiple sub-frames, a sub-frame for which at least one of the multi-color light sources is turned off, the sub-frame immediately preceding a sub-frame for which the at least one of the multi-color light sources is turned on.

3. The liquid crystal display device according to claim 2,
wherein the controller is configured to control the liquid crystal gray scale value of, among the multiple sub-frames, a sub-frame for which at least one of the multi-color light sources is turned off, the sub-frame immediately preceding a sub-frame for which a light source is turned on to emit light in a color with the highest gray scale value of the at least one of the multi-color light sources.

4. The liquid crystal display device according to claim 3,
wherein the controller is configured to control the liquid crystal gray scale value of, among the multiple sub-frames, at least two consecutive sub-frames for which at least one of the multi-color light sources are turned off, the at least two consecutive sub-frames immediately preceding a sub-frame for which a light source is turned on to emit light in a color with the highest gray scale value of the at least one of the multi-color light sources.

5. The liquid crystal display device according to claim 1,
wherein the controller is configured to perform overshoot driving in the liquid crystal layer for, among the multiple sub-frames, a sub-frame for which at least one of the multi-color light sources are turned off, the sub-frame immediately preceding a sub-frame for which the at least one of the multi-color light sources is turned on.

6. The liquid crystal display device according to claim 1,
wherein the multiple sub-frames include only one sub-frame for which the multi-color light source is turned off.

7. The liquid crystal display device according to claim 1,
wherein the multiple sub-frames include multiple sub-frames for which the multi-color light source is turned off.

8. The liquid crystal display device according to claim 1,
wherein every pixel in the display area of the liquid crystal display panel includes a sub-frame for which the multi-color light source is turned off.

9. The liquid crystal display device according to claim 1,
wherein part of the pixels in the display area of the liquid crystal display panel includes a sub-frame for which the multi-color light source is turned off.

10. The liquid crystal display device according to claim 1, further comprising
a thin-film transistor including a semiconductor layer, wherein the semiconductor layer contains indium, gallium, zinc, and oxygen.
